(19) United States
(12) Patent Application Publication
(10) Pub. No.: US 2010/0158308 A1
(43) Pub. Date: Jun. 24, 2010

(54) Digital Cinema Projector Watermarking System and Method

(76) Inventor: Mark Leroy Walker, Castaic, CA (US)

Correspondence Address: Robert D. Shedd, Patent Operations;THOMSON Licensing LLC, P.O. Box 5312, Princeton, NJ, 08543-5312, US

(21) Appl. No.: 11/992,322

(22) PCT Filed: Mar. 3, 2006
(86) PCT No.: PCT/US06/78828

§ 371 Date: Mar. 20, 2008

Related U.S. Application Data
(60) Provisional application No. 60/719,637, filed on Sep. 22, 2005.

(51) Int. Cl. G06K 9/00

(52) U.S. Cl. 382/100

(57) ABSTRACT

Watermarking a projected image for rendering a digital presentation with a watermark coding. The watermark coding uniquely identifies the source of the image presentation. The watermark coding includes a set of images wherein each image defines a watermark image. The images include dots which uniquely define each image relative to the other images in the set by at least an angular relationship between dots of the image.

### CROSS-REFERENCE TO RELATED APPLICATIONS

This application is related to U.S. Provisional Patent Application Ser. No. 60/719,637, entitled “DIGITAL CINEMA PER PROJECTOR WATERMARKING SCHEME”, filed Sep. 22, 2005, which is incorporated by reference herein in its entirety.

### FIELD OF THE INVENTION

The present invention generally relates to watermarking systems and methods and, more particularly, to watermarking a film in accordance with a unique projector identity.

### BACKGROUND OF THE INVENTION

Current Digital Cinema projectors have limited capabilities for displaying unique watermarks for each projector. The current technique utilizes unique subtitle files created for each projector for each distribution. This method is preparation intensive and is not considered scalable for large numbers of screens.

Temporal marking schemes for film printing include a separate process which uses several locations to convey data. The film is marked in a number of locations. Each location is further divided into zones, which are used for rendering a mark.

One of possibilities is encoded by virtue of placing a mark in the corresponding zone for a given location. With several zones dedicated to data unique combinations of marks are available. However, the number of combinations is only sufficient for film-print marking.

Unique marks are created for each film through a prescreening process. Marks are created in preparation prior to distribution. Several aspects of film-print based watermarking do not directly translate to digital cinema. For example, the film-based scheme only provides for approximately 74,000 unique combinations. This falls short of the 128,000 minimum requirements for digital cinema. It would be very difficult to uniquely mark each digital “print” in the same manner as film.

Therefore, a need exists to take advantage of the new digital cinema technology to provide in-situ watermarking during projection.

### SUMMARY OF THE INVENTION

A system for watermarking a projected image, including a source for rendering a presentation with at least one watermark coding identifying the source of the projected image, the watermark coding including at least one image each image defining a watermark and including at least three dots which uniquely define each image.

A method for watermarking a presentation to identify its source, including generating a set of images from watermark files in accordance with an identity of a source of a presentation, each image defining a watermark wherein the images include dots which uniquely define each image relative to the other images by at least an angular relationship between dots of the image.

### BRIEF DESCRIPTION OF THE DRAWINGS

The advantages, nature, and various additional features of the invention will appear more fully upon consideration of the illustrative embodiments now to be described in detail in connection with accompanying drawings wherein:

FIG. 1 is block diagram of an exemplary digital cinema system for creating watermark coding in presentation images in accordance with one embodiment;

FIG. 2 is a diagram showing four unique glyphs which may reproduced in different combinations to achieve watermark coding in an illustrative embodiment;

FIG. 3 is a diagram showing a placement glyph where some of the dots overlap, but the angles between the dots provide unique characteristics for identification of an area for glyph placement;

FIG. 4 is a diagram showing a placement glyph where dots and angles between the dots provide unique characteristics for identification of an area for glyph placement;

FIGS. 5 and 6 are mirror images showing other placement glyphs where dots and angles between the dots provide unique characteristics for identification of an area for glyph placement;

FIG. 7 is a diagram showing a piece of film recorded from a digital presentation showing a location and zone for glyph placement;

FIG. 8 is a block/flow diagram showing an illustrative method for rendering unique watermarks in accordance with aspects of the present invention; and

FIG. 9 is a block/flow diagram showing an illustrative method for forensically determining a unique origin of a film based on the watermark coding in accordance with aspects of the present invention.

It should be understood that the drawings are for purposes of illustrating the concepts of the invention and are not necessarily the only possible configuration for illustrating the invention.

### DETAILED DESCRIPTION OF THE INVENTION

In accordance with embodiments described herein, systems and methods provide images (glyphs), which may be preloaded into a projector and only the timing and spatial positioning of the entire glyph can be modified for a presentation while the glyph itself cannot be modified. In the film-print method the mark (glyph) is essentially customized for each print. The requirements which are addressed by watermarking in accordance with aspects of the present disclosure include, among other things, the following advantages. The scheme permits for the creation of a single subtitle file per distribution which will support multiple screens with a unique watermark result for each screen. The scheme should support a minimum of 128,000 unique combinations, many more are possible, which permits scalability, and permits deployment for use in as many digital cinema auditoriums as possible.

In addition, the scheme provides for data redundancy at the frame and inter-frame level, e.g., the same glyph may be used in different locations of the same digital presentation. The scheme minimizes an amount of time for any temporal encoding. A known constraint regarding subtitles reduces flexibility (see subtitle constraints below). The glyphs presented herein are visually acceptable and not intrusive based on subjective observation. Furthermore, the glyphs are uniquely identifiable from other glyphs, and are robust against partial destruction due to compression or other digital altering techniques. While watermarking techniques are known, specific problems in digital cinema video playback are solved including addressing time constraint issues imposed by existing subtitling mechanisms.

Temporal marking for film may utilize four locations, three of which are used to convey data and the fourth is used as a parity check. Each location may be further divided into 13 zones. Each zone is 8 frames in duration, 3 of which are used for rendering a mark. One of 42 possibilities is encoded by virtue of placing a mark in the corresponding zone for a given location. With three zones dedicated to data 42×42×42=74,000 unique combinations exist. The number of combinations is sufficient for film-print marking. Unique marks are created for each film through a prescreening process. Marks are created in preparation prior to distribution.

In digital cinema physically marking a film is no longer an option, and aspects of the film-print based scheme do not directly translate to digital cinema. The film-based scheme only provides for approximately 74,000 unique combinations. This falls short of the 128,000 minimum requirement dictated by digital cinema standards. Uniquely marking each digital “print” is not possible in the same manner as physical film marking. In accordance with one embodiment, images (glyphs) may be preloaded into a projector and only timing and spatial positioning of the entire glyph can be modified for a presentation while the glyph itself cannot be modified. In the film-print method the mark (glyph) is essentially customized for each print which makes scalability nearly impossible.

It is to be understood that the present invention is described in terms of a digital projector system; however, the present invention is much broader and may include any digital multimedia system, which is capable of digital delivery over a network. In addition, the present invention is applicable to any replay method including, e.g., data delivered or played back by telephone, set top boxes, computer, satellite links, etc. The present invention will now be illustratively described in terms of a digital cinema projector system.

It should be understood that the elements shown in the FIGS. may be implemented in various forms of hardware, software or combinations thereof. Preferably, these elements are implemented in a combination of hardware and software on one or more appropriately programmed general-purpose devices, which may include a processor, memory and input/output interfaces.

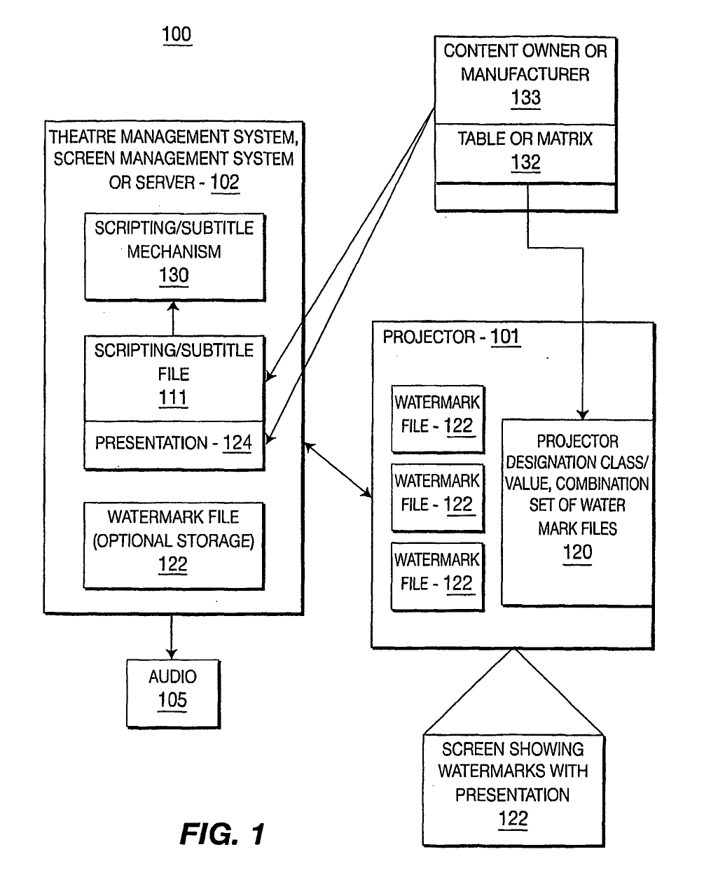

Referring now in specific detail to the drawings in which like reference numerals identify similar or identical elements throughout the several views, and initially to FIG. 1, an illustrative digital cinema system 100 includes a computer or equivalent digital rendering display device 102, such as e.g., a digital cinema server, theater management system or screen management system. Movie distribution and exhibition is currently in transition from using film as the distribution and exhibition medium to using digital media that are distributed as computer files and exhibited using digital cinema playout servers 102, digital projector(s) 101 and audio processors 105. Digital cinema server 102 is configured to render a presentation 124.

Projector 101 includes a factory assigned watermark designation or class or a set of watermark combinations 120. The designation 120 permits that particular projector 101 to display a particular watermark file or files 122 as provided to (e.g., downloaded to) device 102 or projector 101. A plurality of watermark files 122 is provided. Images of watermarks are generated in accordance with the files 122. A selection of which watermarks will be displayed may be determined in accordance with a set of watermarks selected or determined by a content owner or manufacturer 133. Content owners may employed a table or matrix 132 to determine the set of watermark files 122 designated for a particular projector 101. Watermark files 122 are preferably included at the time of manufacture or in advance of placement of the projector in a theatre.

A script/subtitle track or file 111 is included with a presentation 124 to be rendered and may be formatted in a similar fashion as a subtitle track or file 111. Note that the watermark files 122 are preferably PNG image files, while the normal subtitle files including subtitle information are an xml/text file including the subtitling instructions for a given presentation.

A per-projector watermarking method provides unique visible watermarking per digital projector despite having a common playback scripting mechanism 130. The scripting mechanism 130 controls the digital cinema playback of the video and other ancillary data (such as subtitle information). By exploiting the graphics capability of the subtitling mechanism 130, watermarks can be placed over the video during the projection process.

To achieve unique watermarking per projector, a special “sequence” of watermark files 122 is used to emulate a temporal watermarking scheme. Further, for simple watermarking symbols, the watermark can be deftly placed in a frame to reduce annoyance of visible watermarking to the viewers of the presentation.

The subtitle/scripting language as provided by scripting/subtitle mechanism 130 describes when (e.g., frame/timecode), where (e.g., x, y screen coordinates), and what file to display (e.g., png image). In accordance with the present embodiments, the watermarking file names are common for all projectors (101) for a given presentation (124). Temporal modulation of the watermark is achieved through the use of null and non-null images, which are stored with the common names of the watermark files 122. Null images result in no mark rendered to a screen 134 while the non-null images result in a rendered watermark. This may be implemented using scripting mechanism 130 to give projectors instructions as to what, when and where watermarks are to be generated and depicted on a projection screen.

Advantageously, a same scripting language file 111 controls the video playback for each digital cinema projector 101 (for each individual movie). This scripting language file 111 can specify when (frame/time code) a specific watermark will be presented, where (x, y) a specific watermark will be presented, and the names of the files that include the watermarks. Note that the same watermark file names are used for each projector; however, the contents of these files do not have to be the same. In fact, to achieve an emulated temporal watermarking scheme, the contents of the files are preferably different. In one embodiment, the content of the watermarks may be preloaded on server 102 and loaded when the appropriate watermark file name is called for from the scripting mechanism 130.

As an example, four projectors receive identical instructions to render watermarks: file1, file2, file3 and file4 in sequence (x, y positioning is ignored in this example). Based on the contents of the image files for each projector the following temporal encoding can be achieved:

TABLE 1
Subtitle Instruction Matrix

| | Render File1 | Render File2 | Render File3 | Render File4 |
|---|---|---|---|---|
| Projector1 | Non-null | Null | Null | Null |
| Projector2 | Null | Non-Null | Null | Null |
| Projector3 | Null | Null | Non-Null | Null |
| Projector4 | Null | Null | Null | Non-Null |

So in the example, projector1 will render file1, which may include a particular glyph. The sequence is continued so that a same or different glyph is rendered at a next zone or location in accordance with the projector class or assigned value. When and where file1 is rendered may also be assigned using a similar technique. For example, an x and y position may be given and frame numbers assigned as to when a watermark (glyph) of file1 will be displayed on the projection screen. Based on the contents of the image files for each class of projector 101 unique image, spatial and temporal encoding is achieved.

While the watermark files 122 may be similar to subtitling Image files, the watermarking files have stricter rendering rules, and the subtitling mechanism 130 may not be appropriate given some of the following constraints. It is not recommended to mix subtitle text with images. The timing of the images will no longer be reliable since the timing is affected by the timing of the text. Images used for watermarking should remain relatively small. Larger images tend to render line-by-line and also affect the timing of the display. Displaying images should be for a minimum of about 36 ticks (one tick is 1/250 seconds) or roughly 3 frames, otherwise the image may not render. It takes at least 3 frames from the end of displaying one image to the beginning of displaying the next. This leads to a minimum image time start-to-start of about 6 frames. 8 frames may be used for historical reasons. These restrictions may not apply in all subtitling mechanisms, but are provided as an illustration of factors to be considered. In a preferred embodiment, a single frame watermark rendering may be employed.

The images of the presentation with watermarks are then displayed on a display screen 134. The display screen 134 shows the content of the presentation with visible but unobtrusive watermark glyphs. In this way, illegal pirating can be traced to a unique projector or other source.

Some heuristics suggest that 3 dots per mark are reasonably unobtrusive to the viewer. However, more dots or shapes, e.g., five or six dots, may be used successfully for marking schemes. It should be understood that dots shall be taken to mean a relative position represented by a geometric image. Dots may have any shape, e.g., square, circle, triangle, ellipses, or any other shape or image.

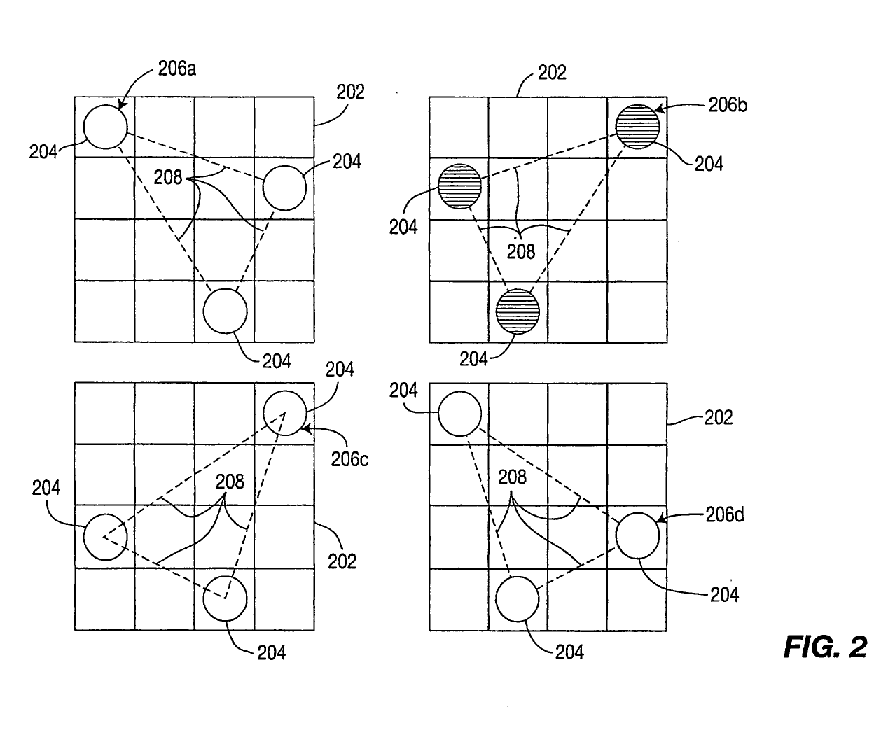

Referring to FIG. 2, In accordance with preferred embodiments, a glyph design is based on a 4 by 4 matrix 202 which includes several dots 204. It is to be understood that matrix 202 may be sized to permit scalability and permit larger or smaller number of glyph combinations. In one embodiment, a “knight's move” pattern (e.g. one up, two or more over) may be employed to avoid undesirable vertical, horizontal or 45 degree dot alignment, which tends to catch the eye of the viewer and therefore result in an undesirable mark.

The marks are comprised of four unique glyphs 206a-d. Each glyph 206 is made of three dots 204. Four glyphs 206a-d permit for optimized encoding in the temporal domain as will be described below. Although dots are shown, the glyphs may be comprised on any geometric shape, e.g., squares, triangles, etc., images, logos or other shapes.

Each glyph 206 is unique in that the orientation of dots 204 is unique to that glyph; specifically the angles of lines 208 connecting each dot 204 within a glyph 206 are not repeated. The relationship between any two dots 204 does not repeat across glyphs 206. This unique relationship provides robustness against data loss when a single dot has been lost due to compression or image manipulation. If a dot 204 is missing, the glyph 206 can still be uniquely identified with two remaining dots. It should be understood that the matrix 202 and lines 208 are not rendered in the watermark, but are presented here to illustrate the concepts involved in placement of the dots 204.

Glyphs 206 can be oriented in such a way that when placed in a matrix 202 no single dot overlaps between glyphs 206 and can therefore be uniquely identified using only a single dot. This may need registering the content under analysis having watermarks with an original version of the content with watermarks to obtain an absolute reference.

When placing a glyph 206 for watermarking purposes, it is useful to composite all the glyph possibilities into a single “placement glyph.” The placement glyph provides a useful tool for summarizing the set of glyphs used in a particular presentation, and can be used to assist in the placement of the watermarks in a frame or frames to reduce intrusiveness.

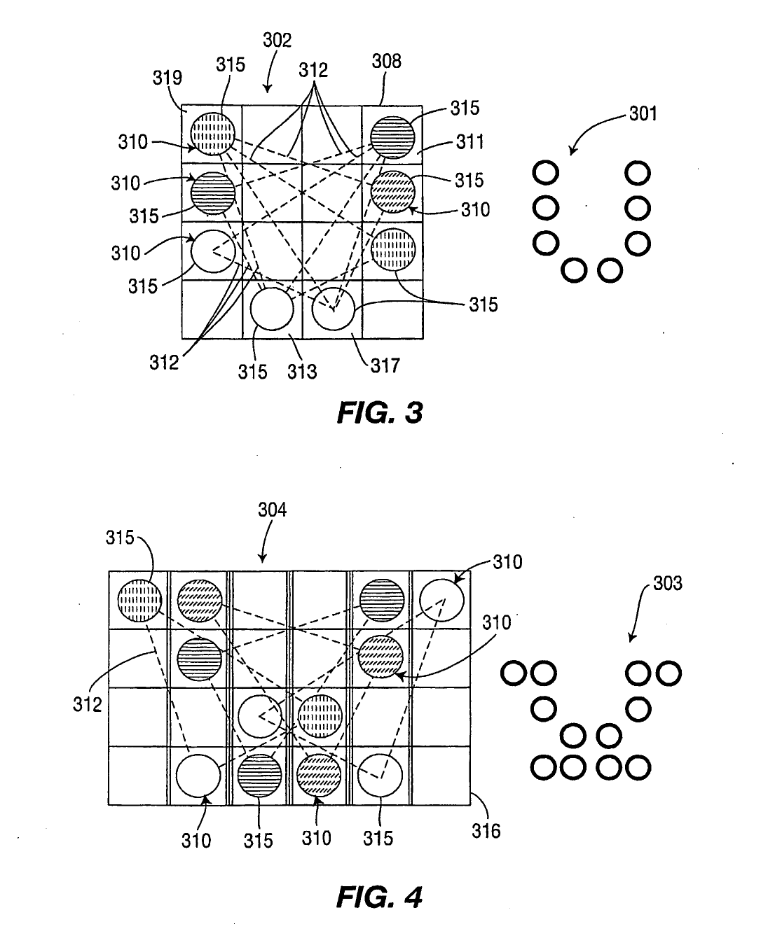

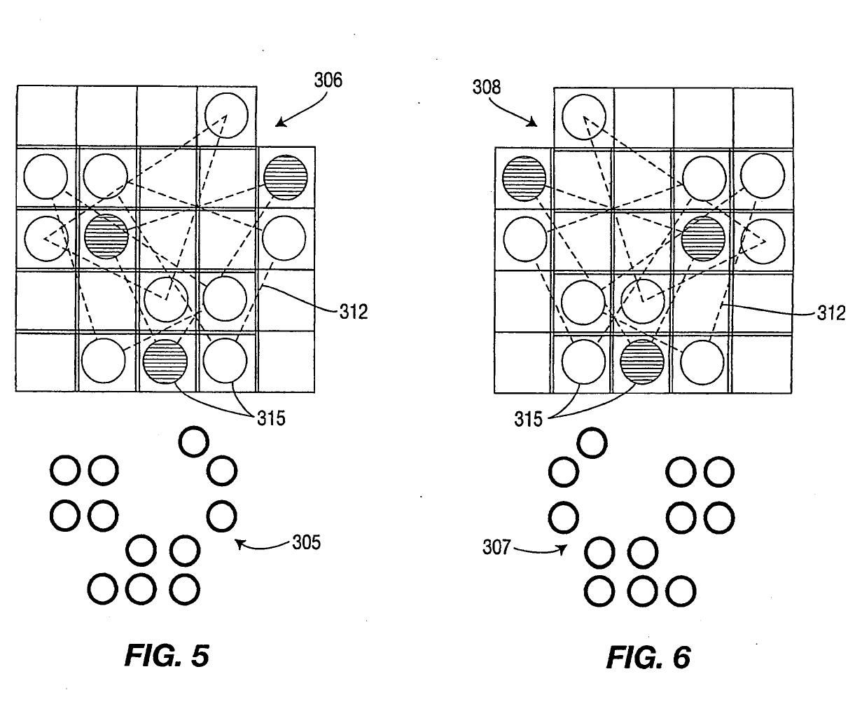

Referring to FIGS. 3-6, various arrangements for placement glyphs 302, 304, 306, and 308 are illustratively shown. The placement glyph combines all of the glyphs (e.g., 206a-d) that will appear in a given presentation. In one embodiment, four glyphs are employed in a single presentation. These four glyphs 206a-d (FIG. 2) may be combined to form a record of the glyphs for a single presentation. In this way, a single symbol or image (as illustratively depicted in images 301, 303, 305, or 307) can be employed to summarize the glyphs in a presentation. Comparisons to a presentation may be compared to a presentation using the placement glyph to identify the presentation's projector based on the dimension of glyph type.

Placement glyphs 302, 304, 306, and 308 form different shapes. For example, placement glyph 302 forms a cup shape on a 4×4 matrix grid 308 including a composite of four glyphs 310. Several dots 315 overlap in locations 311, 313, 317 and 319. Angles between lines 312 connecting dots 315 provide The unique features.

Placement glyph 304 includes a goblet shape with the same four glyphs 310 of placement glyph 302; however, the glyphs 310 do not overlap and are instead presented on a 6×4 matrix grid 316. This placement glyph 304 includes both unique angles and unique dot placement.

Other placement glyphs and glyph combinations are also contemplated. Examples include placement glyphs 306 and 308, which show a 5×5 matrix grid 320 with different arrangements of four glyphs 310. The glyphs of placement glyph 306 are a mirror image of those in placement glyph 308. Both placement glyphs 306 and 308 include both unique angles and unique dot placement.

Dot size and intensity (contrast) for glyphs may be determined based on empirical experiments to ensure survivability in typical situations (e.g. camcorder copying). The dots of a glyph should be perceivable by a viewer to the extent necessary to be present on a recorded version of the presentation but should not be intrusive to the viewer. In this way, the watermark can be deciphered in a boot-legged copy of a movie without detracting from the viewing experience of a legitimate viewer.

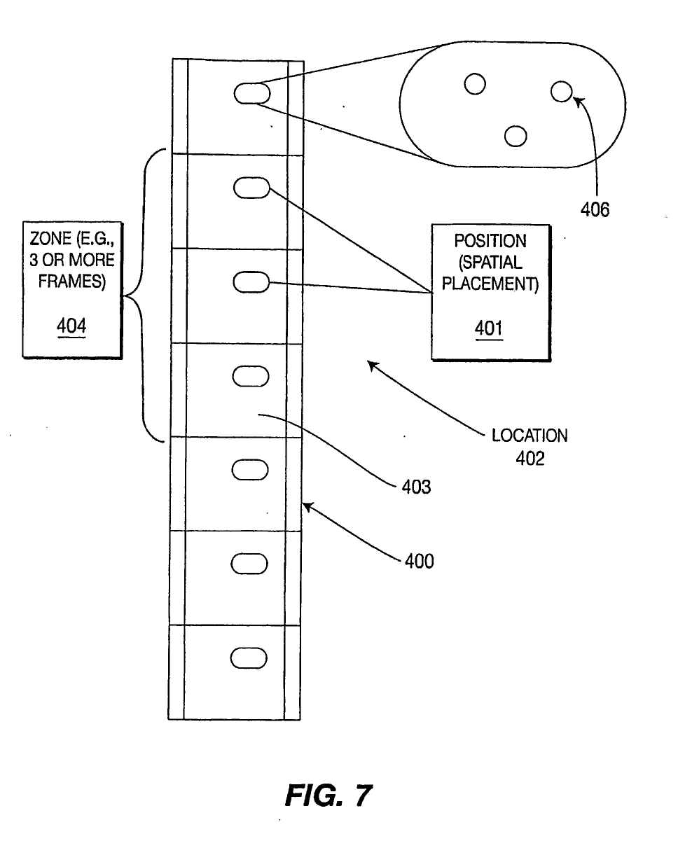

Referring to FIG. 7, in one illustrative embodiment, an encoding scheme uses four locations each comprised of thirteen zones. FIG. 7 illustratively shows a piece of film so as to indicate the locations and zones in a tangible way. It should be understood that the only film recording that would include these features is one that is recorded from a theater presentation, which is illegal without proper permission. The film illustratively shows a single location 402 and one zone 404 (comprising 3 or more frames). The four locations 402 are located in different areas or portions of a presentation. The four locations may occupy a different portion of a same frame or frames, or may be on different frames. A watermark 406 may be placed in a particular position 401 in a frame 403, e.g., on screen locations or locations within a frame or frames 403 of content.

Using one of four glyphs (one glyph 406 is illustratively shown) in one of 13 zones to encode data in a given location yields 4×13 or at least 52 combinations per location. Using three locations provides 52×52×52=140,608 unique combinations in all. This exceeds the 128,000 unique combination goal as described above. The fourth location 402 may be used for parity calculations. A location in the context of encoding values is a set of (13) zones and represents a value based on the glyph selected and the zone in which it appears.

A parity calculation may be performed in advance and may be part of the watermarking scheme. In one example, the parity is precalculated and becomes part of the pre-deployed watermark value. For example, in the implementation where 3 locations are assigned values, the 4^{th} (parity) location is calculated based on the sum of the values encoded into the first three locations then a modulo is used after divided by a number, for example, a number of combinations, say 52 in this case. Other parity formulas and values may be employed.

In the present example, the series of values provide 52 different possibilities for each location. The parity provides an additional check. The answer of the parity calculation is displayed on screen at a (e.g., fourth) location, but the other location values need not be displayed, but may correspond to a table or matrix kept by the content owner or other authorized entity.

Each zone 404 is similarly treated as for film-based schemes where a zone 404 is about 8 frames long of which about 3 frames are used to render a glyph. One frame is preferable for rendering the mark/glyph. It should be noted that since the glyphs are digitally rendered the glyph may appear over all 8 frames or over more or less frames depending on the circumstances.

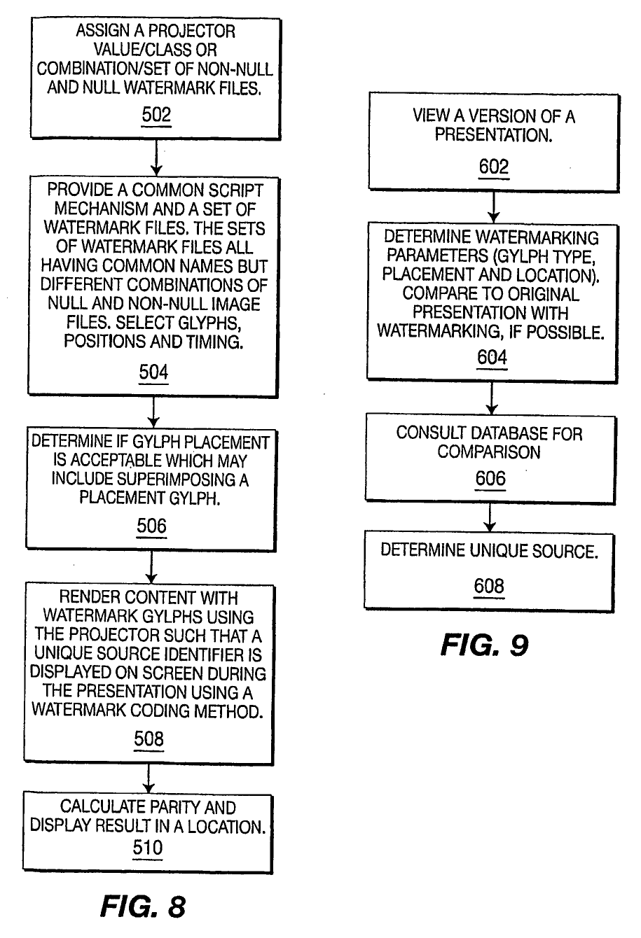

Referring to FIG. 8, a method for applying watermarks during projection to identify the projector or source is illustratively described and shown. In block 502, a digital image projector is assigned a value (e.g., projector1 in Table 1) or otherwise set up in accordance with a watermark scheme to permit the selection of watermarks that will be shown and at which locations in a presentation. For example, a predetermined combination of null and non-null watermark files may be provided to the projector. The combination of null and non-null image files is retained by the manufacturer or content owner for forensic value when needed to identify the projector. The value or combination of files (file set) may be assigned by or otherwise provided by, for example, a projection manufacturer or content owner. The set may be input into the system server or may simply be included on the projector. This set or combination of files contributes to the uniqueness of the watermarking during deployment of the presentation.

In block 504, a single scripting mechanism is employed to determine which watermarks are displayed in accordance with the projector class/designation or set or assigned watermark files (null and non-null combinations). The watermark files are provided in advance on the projector. The single script file includes information for a plurality of image files or watermark files (e.g., WM1 in Table 1) with watermark information. The correct files (glyphs) to be rendered are selected in accordance with the script file indicating when and where the watermark files are rendered for that projector. These unique sets of image files (watermarks) are created and deployed for each projector. The sets include all the same file names for the watermark files, but each set has a different combination of null and non-null watermark files. This “pre-modulates” the temporal and watermark information for each projector. Advantageously, all subsequent presentations may use the same relative timing and watermarks in the zones while the detailed timing and positioning (locations) may be determined by the subtitle/script file which is sent with the presentation.

In block 506, for watermarking, the content is screened to locate a position in the frames where the water mark will be visible. A placement glyph may be employed as a tool to make sure that all dots are viewable for the series of glyphs. While the placement glyph is helpful, at most only three of the dots will be shown for a given projector at one time (unless the locations share frames). It is preferable to employ a unique absolute positioning glyph pattern (e.g., no overlapping dots) to support single-dot or reduced dot decoding.

In block 508, during a presentation, in accordance with the projector designation and the image file to be rendered, a unique watermark coding is digitally rendered for a single projector. The watermarks include a sequence of glyphs; each glyph preferably includes a three dot pattern without vertical, horizontal or 45 degree lines between the dots. The glyphs are preferably run at one or more locations in the presentation and included in 13 zones (or a sequence of 4 glyphs combined in 13 places). In a preferred embodiment the glyphs are run in four locations in 13 zones per location. The watermark coding is unique to that projector.

In one embodiment, four locations are employed for rendering watermarks. Each location includes 13 zones, and each zone includes 8 frames. The placement of one or four glyphs can be done in different zones and at different locations to provide the possibility or 52 combinations of glyph presentations. For example, a single glyph may be selected from four glyphs. A single glyph may be used once at each location but the zones are changed for the glyphs placement. This gives 52 combinations per location (4 glyphs times 13 zones).

In block 510, a parity calculation may be performed in advance and may be part of the watermarking scheme. In one example, the parity is precalculated and becomes part of the pre-deployed watermark value. For example, in the implementation where 3 locations are assigned numeric values, the 4^{th} (parity) location is calculated based on the sum of the values encoded into the first three locations then a modulo is used after divided by a number, for example, a number of combinations, say 52 in this case. Other parity formulas and values may be employed. The parity value may be displayed in a zone other than a zone where a glyph is present.

As an example, Table 2 demonstrates four locations each having a series of values. The series of values provide 52 different possibilities for each location. Location D is a modulo 52 of the sum of the values for corresponding zones values for the three locations A, B and C. Other parity formulas and schemes may be employed.

TABLE 2

| Location A | Location B | Location C | Location D |
|---|---|---|---|
| 1 | 1 | 1 | 3 |
| 13 | 13 | 13 | 39 |
| 26 | 26 | 26 | 26 |
| 1 | 13 | 26 | 40 |
| 51 | 51 | 51 | 49 |

The parity provides an additional check. The answer of the parity calculation is displayed on screen at a (e.g., fourth) location, but the other location values need not be displayed, but may correspond to a table or matrix kept by the content owner or other authorized entity.

Referring to FIG. 9, a method for employing the water mark to determine a projector from which a presentation was rendered is illustratively shown. In block 602, a presentation version (e.g., an illegally copied film) is reviewed to determine watermarkings. Detection can be accomplished using multiple techniques. In the case where all dots and in most cases only two dots exist for a given glyph the glyph can be directly decoded. The angle of alignment between dots can be used to differentiate glyphs when only two dots are readable. In the case of a single dot and perhaps some two-dot scenarios, registration with the original content may be used for decoding. Tools created to facilitate detection may include digital computer tools with magnification capabilities and the ability to view the presentation frame by frame.

In block 604, a determination of the watermarking parameters is determined. For example, the locations, glyph sequence in the zones and types of glyphs is made. For scenarios where mirroring, rotation or skew are injected into the image's registration, a comparison with the original image is recommended to avoid misinterpretation of the glyph. In the case where a mark is obliterated, blurred or frames cut from the footage, some data can still be retrieved based on temporal encoding. This is done by recognizing the specific location in time that has been modified and therefore the specific temporal encoding parameter (one of 13 zones within a given location).

In block 606, a database of projectors is consulted to determine which projector rendered the film. The database will include the glyph types and the combination of glyphs in sequences as well as locations where the glyphs were positioned for a given presentation. In this way, a unique projector will be determined in block 608.

The following table outlines the effects of some illustrative whole-mark attacks:

TABLE 3

| Attack | Effects |
|---|---|
| A glyph in one of the four | The parity location is used to |
| locations is attacked or an | reconstruct the original |
| entire location is removed. | identification. |
| Two of four glyphs are | Data from two decodable locations |
| attacked but the temporal | will narrow the possibilities to a |
| positions can be ascertained | set of four (4) possible codes. |
| by the time positions of the | |
| attacked frames. | |
| Three of four glyphs are | Data from one decodable location |
| attacked but the temporal | will narrow the possibilities to a |
| positions can be ascertained | set of sixteen (16) possible codes. |
| by the time positions of the | |
| attacked frames. | |
| All four glyphs are attacked | Data derived solely from the |
| but the temporal positions | temporal encoding will narrow the |
| can be ascertained by die | possibilities to a set of sixty-four |
| time positions of the | (64) possible codes. |
| attacked frames. | |

Having described preferred embodiments for system and method for digital cinema projector watermarking system and method (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention as outlined by the appended claims. Having thus described the invention with the details and particularity required by the patent laws, what is claimed and desired protected by Letters Patent is set forth in the appended claims.

1. A system for watermarking a projected image, comprising:
a source for rendering a presentation with at least one watermark coding identifying the source of the projected image, the watermark coding including
at least one image each image defining a watermark and including at least three shapes which uniquely define each image.

2. The system according to claim 1, wherein the at least shapes uniquely identify each image by an angular relationship between the at least three shapes.

3. The system as recited in claim 1, wherein the at least one image is a set of images which comprises all of the images for watermarking a given presentation.

4. The system as recited in claim 1, further comprising a scripting mechanism which determines a manner in which the image is rendered.

5. The system as recited in claim 4, wherein the scripting mechanism renders all watermark files without knowing which image is rendered.

6. The system as recited in claim 1, wherein the shapes of the image are positioned relative to each other such that connecting lines between the dots present lines which are other than horizontal, vertical or 45 degrees in orientation.

7. The system as recited in claim 1, wherein connecting lines between shapes form angles which are unique to each image.

8. The system as recited in claim 3, wherein the set of images includes four images.

9. The system as recited in claim 8, wherein a pattern of the four images is positioned in 13 zones during the presentation.

10. The system as recited in claim 3, wherein the set of images are rendered in at least four locations of the presentation.

11. The system as recited in claim 1, wherein the shapes are positioned in accordance with a reference grid.

12. The system as recited in claim 1, wherein the shapes are positioned such that shape positions are unique for each said image in a plurality of the images.

13. The system as recited in claim 1, wherein the watermark coding includes a location having a parity calculation.

14. The system as recited in claim 1, wherein the shapes include any geometric shape.

15. A system for watermarking a projected image, comprising:
at least one image defining a watermark, the image including shapes which uniquely define said image, the dots being at least three shapes which form at least an angular relationship between the shapes to uniquely define said image.

16. The system as recited in claim 15, wherein at least one image is a plurality of said image for watermarking a given presentation.

17. The system as recited in claim 15, further comprising a scripting mechanism which determines a manner in which the image is rendered.

18. The system as recited in claim 15, wherein the shapes include any geometric shape.

19. The system as recited in claim 15, wherein the shapes of the image are positioned relative to each other such that connecting lines between the shapes present lines which are other than horizontal, vertical or 45 degrees in orientation.

20. The system as recited in claim 15, wherein connecting lines between the shapes form angles which are unique to said image.

21. The system as recited in claim 16, wherein the set of images includes four images.

22. The system as recited in claim 21, wherein a pattern of the four images is positioned in 13 zones during the presentation.

23. The system as recited in claim 15, wherein the set of images are rendered in at least four locations of the presentation.

24. The system as recited in claim 15, wherein the shapes are positioned in accordance with a reference grid

25. The system as recited in claim 15, wherein the shapes are positioned such that shape positions are unique for each image in a plurality of said image.

26. A method for watermarking a presentation to identify its source, comprising:
generating a set of images from watermark files in accordance with an identity of a source of a presentation, each image defining a watermark wherein the images include shapes which uniquely define each image relative to the other images by at least an angular relationship between shapes of the image.

27. The method as recited in claim 26, further comprising rendering a presentation along with the set of images wherein the set of images are arranged to uniquely identify said source of a presentation.

28. The method as recited in claim 26, wherein the images are constructed from a plurality of shapes, and further comprising positioning the dots relative to each other such that connecting lines between the dots presents lines which are other than horizontal, vertical or 45 degrees in orientation.

29. The method as recited in claim 28, wherein the connecting lines form angles which are unique to each shape in the plurality of glyphs.

30. The method as recited in claim 26, further comprising providing a selection of four images such that the four images are selectively placed in different zones of the presentation.

31. The method as recited in claim 27, wherein rendering includes rendering images in at least four locations of the presentation.

32. The method as recited in claim 26, wherein the dots are positioned in accordance with a reference grid.

33. The method as recited in claim 26, wherein the dots are positioned such that dot positions are unique for each image in the set of images.

34. The system as recited in claim 27, wherein rendering includes employing a subtitling mechanism.

35. The system as recited in claim 26, further comprising providing a placement image which is a composite of the set of images and determining a placement of the images in the presentation using the placement image.

36. A method by a film projector comprising:
projecting at least one watermark coding identifying the source of a projected image, the watermark coding including at least one image defining the watermark.
